(19) United States
(12) Patent Application Publication
(10) Pub. No.: US 2011/0027472 A1
(43) Pub. Date: Feb. 3, 2011

(54) Method, Composition, and Kit for Clarifying and Sealing Oxidized Headlights

(75) Inventor: Steven J. HOWELL, Boca Raton, FL (US)

Correspondence Address: ASSOULINE & BERLOWE, 3250 MARY ST STE 308, Miami, FL, 33133-5232, US

(73) Assignee: Crystal View Chemicals, Inc., Boca Raton, FL (US)

(21) Appl. No.: 12/511,561

(22) Filed: Jul. 29, 2009

(51) Int. Cl. C08K 5/16; B05D 5/06; C08K 5/3415

(52) U.S. Cl. 427/162; 524/199; 524/104

(57) ABSTRACT

A process, a composition, and a kit clarify and seal oxidized lens, especially headlight lenses. The process involves abrading the lens to remove oxidation and the sealing the lens with an aqueous urethane-modified acrylic sealer that includes an aqueous styrenic-acrylic emulsion or an aqueous polyethylene emulsion. The composition includes the sealant. The kit is an at-home device including the composition and utilizing the method.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to compositions and method for clarifying oxidized headlight lenses and then sealing the clarified lenses.

2. Description of the Related Art

Headlight “fading” is a condition that affects an automobile's ability to project light effectively. As opacity increases, light projection is reduced. Reduced light projection limits a driver's ability to see at night and reduces reaction time while driving in dark, twilight, or inclement weather. Therefore, headlight fading puts drivers, passengers, other motorists, and pedestrians at risk of accident.

Headlight fading is caused by chemical reactions occurring in the lens. Typically, headlight lenses are made from polycarbonate. Polycarbonate reacts with ultraviolet light and other environmental contaminants and oxidizes. The oxidation makes the normally clear lens cloudy and even yellow.

To retard the oxidation process, the factory may include a film over the polycarbonate that filters ultraviolet light. Over time the film's effectiveness deteriorates, and the UV reaction still occurs. In addition, the film can be damaged, scratched, or removed.

A first possibility is to replace the lens. However, because modern headlights are formed as integrated units including the lens, the entire headlight usually must be replaced. The cost of replacing a headlight is significant.

The simplest way to clarify a lens is to abrade the lens. Sanding and polishing will remove the oxidized outer layer. Unfortunately, abrading also removes any factory-installed coating. The result is the sanded lens will deteriorate quickly to a faded state because the protective coating has been removed.

Another alternative is using chemical solvents (i.e. non-aqueous organic solvents) to polish the lenses. First, the effectiveness of such solvents is questionable. In fact, the Applicant's research suggests that solvents may damage the lens. Second, for home use, the health and accident risks involving solvents are prohibitive. For commercial use, the risks, liability, and cleanup of organic solvents makes their use impracticable.

Methods for clarifying and sealing oxidized headlights have been proposed. However, the prior-art systems fail for at least one of the following reasons.

First, the system includes significant amounts of solvents. That is the primary solvent for the sealant is an organic solvent. Solvent-based systems dry quickly. However, they are volatile. In a commercial work shop, the solvents are dangerous and hazardous to the workers. The solvents are expensive to store, dispose, and clean. In home application, the solvents are dangerous to the users and pose a risk when stored. Their incorrect use can also damage the finish of a car.

Traditional aqueous sealants are not effective because they take too long to dry. Research has shown that for a sealant to be commercially useful, it must have a drying time of about five minutes. Longer drying times provide too high opportunity cost to the shop. For home users, long drying times risk contamination to the coating during drying.

Kropp et al. (US 2006/0201378) teaches a pretreatment formulation, resurfacing formulation, and a restoration formulation. The pretreatment formulation uses a volatile citrus terpene solvent. The resurfacing formulation includes a distillate, a polish, and water. The restoration formulation includes an aqueous polymer and water: in particular, metylmethacrylate and ethyl methacrylate, isocyanate polyurethane, N-methylpyrrolidone and triethylamine, or inhibited methylmethacrylate emulsion and or water miscible methylmethacrylate. Kropp et al. does not teach a system that is aqueous based and that can dry two coats of sealant in five minutes.

Ripley (US 2006/0263527) teaches cleaning but only to remove dirt, not to abrade oxidation. Ripley uses a caustic solution, which is hazardous. For a sealant, Ripley teaches one or more urethane coatings. Ripley does not specify what solvent is being used nor does it discuss a drying time.

Toth, III (US 2006/0217041) teaches three levels of sanding: 240X, 400X, 1000X. Toth does not teach a polymer sealant.

Cole et al. (U.S. Pat. No. 7,163,446) teaches to abrade a surface and then seal it with a film forming aqueous acrylic/urethane copolymer dispersion and UV protectant. The primary solvent is N-Methylpyrrolidone (NMP).

### BRIEF SUMMARY OF THE INVENTION

It is accordingly an object of the invention to provide a method for clarifying and sealing a lens of a light, a composition for sealing a lens of a light, and a kit for clarifying and sealing a headlight, all of which overcome the above-mentioned disadvantages of the heretofore-known methods, compositions, and kits of this general type.

An object of the invention is to provide a method for clarifying an oxidized lens, in particular an oxidized headlight lens, and then sealing the clarified lens to minimize future oxidation.

A further object of the invention is to provide a composition that can be applied in two coats and dry in less than ten minutes, and more preferably less than five minutes, to a level where the sealant is no longer tacky and at risk of contamination if the automobile with the headlights is driven. This timing has been found to be a key time restraint for commercial garage applications. In these situations, the service provider will only use a product if the restoration process is relatively profitable for a given period of time. Otherwise, the repair-shop owner will use a bay for more profitable uses. In addition, the commercial user must be confident that the lens has sufficiently cured to allow the car owner to leave without risking the outcome of the job.

A further object of the invention is to provide a sealant with no or trace amounts of organic solvent. Chemical solvents are both fire and health risks. Compositions that include organic solvents are subject to environmental regulation. Commercial service centers tend to aggregate chemical wastes so even low amounts can aggregate to a significant amount. Trace amounts of organic solvent are amounts less than 2.5% weight. Trace amounts evaporate quickly enough that they do not accumulate to provide a health or safety risk, even in commercial uses.

In accordance with the objects of the invention, a method of sealing a surface of a lens to prevent oxidation of the lens is provided. The method for sealing can be performed after clarifying the lens or can be performed prophylactically to prevent oxidation of the lens. The method involves applying a coating that includes an aqueous urethane-modified acrylic sealer to the surface. The aqueous urethane-modified acrylic sealer includes an aqueous styrenic-acrylic emulsion. This combination has been found to produce a durable sealant that cures quickly enough to allow two coatings to be applied within five minutes.

In accordance with the objects of the invention, a second embodiment of a method of sealing a surface of a lens to prevent oxidation of the lens is provided. This method also calls for applying an aqueous urethane-modified acrylic sealer to the surface. The aqueous urethane-modified acrylic sealer includes an aqueous polyethylene emulsion. The inclusion of the aqueous polyethylene emulsion has also been found to produce a sealant that cures quickly enough to allow two coatings to be applied within five minutes.

In accordance with a further object of the invention, the method can provide for applying an aqueous urethane-modified acrylic sealer that includes both an aqueous styrenic-acrylic emulsion and an aqueous polyethylene emulsion.

In accordance with a further object of the invention, the surface of the lens is abraded before applying the aqueous urethane-modified acrylic sealer. Abrading the surface removes existing oxidation from the surface of the lens and prepares the surface to be sealed. Abrading can be performed by sanding and/or polishing. Typically, a series of finer abrasives are used to clarify an oxidized lens.

In accordance with a further object of the invention, the method calls for applying two coats of the sealant to the surface of the lens. The second coat helps to complete the seal and creates a smooth finished surface. The second coating is applied in the same direction as the first, preferably a continuous film from the top of the lens to the bottom.

By including an aqueous styrenic-acrylic emulsion and/or an aqueous polyethylene emulsion in the aqueous urethane-modified acrylic sealer, each coating dries quickly enough that two coating can be applied within five minutes and the sealant will have had enough time to at least partially cure to a degree in which normal driving of a vehicle will not compromise the seal.

In accordance with the objects of the invention, a composition is provided for sealing a surface of a lens. The compound includes an aqueous urethane-modified acrylic sealer. The aqueous urethane-modified acrylic sealer includes an aqueous styrenic-acrylic emulsion and/or an aqueous polyethylene emulsion.

In accordance with a further object of the invention, the sealant composition can include a polyurethane dispersion.

In accordance with a further object of the invention, the sealant includes n-methly-2-pyrolidone. N-methyl-2-pyrolidone accelerates the drying of the sealant after the sealant has been applied. The amount of N-methyl-2-pyrolidone is limited, preferably to less than three percent, to prevent the composition from being hazardous.

In accordance with a further object of the invention, a kit for clarifying and sealing a surface of an automobile headlight is provided. The kit includes all of the materials that for clarifying and sealing a lens of a headlight that are not normally available to a user. The kit includes coarse and fine sandpaper, polishing cream, a lint-free cloth, and a container of sealant. The coarse sandpaper has a grit no greater than 1000 for coarse abrading the surface of the automobile headlight. The fine sandpaper has a grit greater than 1000, and preferably as high as 3,000, for fine abrading the surface of the automobile headlight. The polishing cream polishes the surface of the automobile headlight after abrading. The polishing cream is stored in a single-use packet that can be torn open by hand. The amount of polish included in the package is an amount necessary to polish two large headlights. Accordingly, the amount of unused polish, which will require disposal, is minimized. A lint-free cloth is included for applying the polishing cream. Sealed packets that can be torn open by hand of the sealer are included. The packets hold a volume of the sealant that is sufficient to coat the surface of both of the headlight lenses twice. This amount provides enough to complete a single car but does not provide an excess of the sealant, which may be difficult to dispose. Household items like paper towels and a squirt bottle can be included or omitted to save packaging space and reduce cost.

Other features which are considered as characteristic for the invention are set forth in the appended claims.

Although the invention is illustrated and described herein as embodied in a method, a composition, and a kit for clarifying and sealing oxidized headlights, it is nevertheless not intended to be limited to the details shown, because various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a front side view of an automobile according to the Prior art.

FIG. 1A is a partial closeup view according to the prior art of a headlight shown in FIG. 1.

FIG. 2 is a diagrammatic perspective view of kit according to the invention.

FIG. 3 is a diagrammatic view of the contents of the kit shown in FIG. 2.

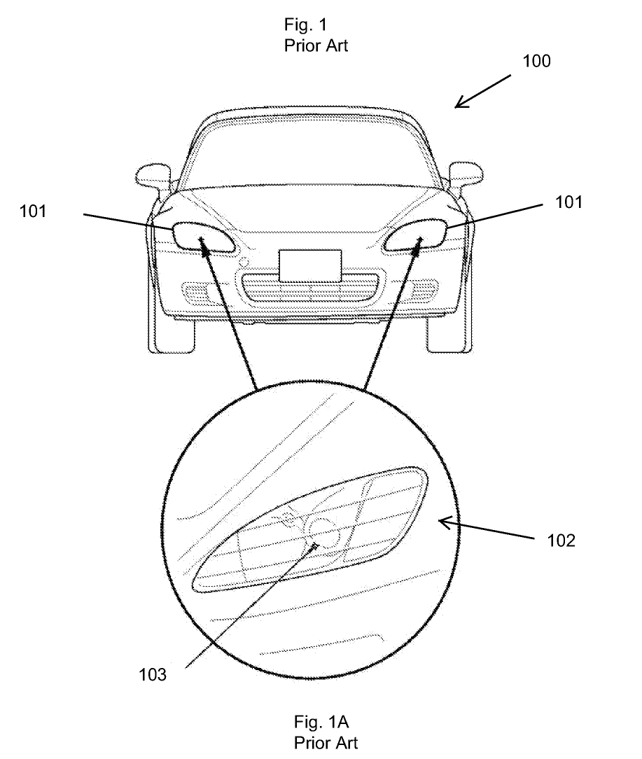

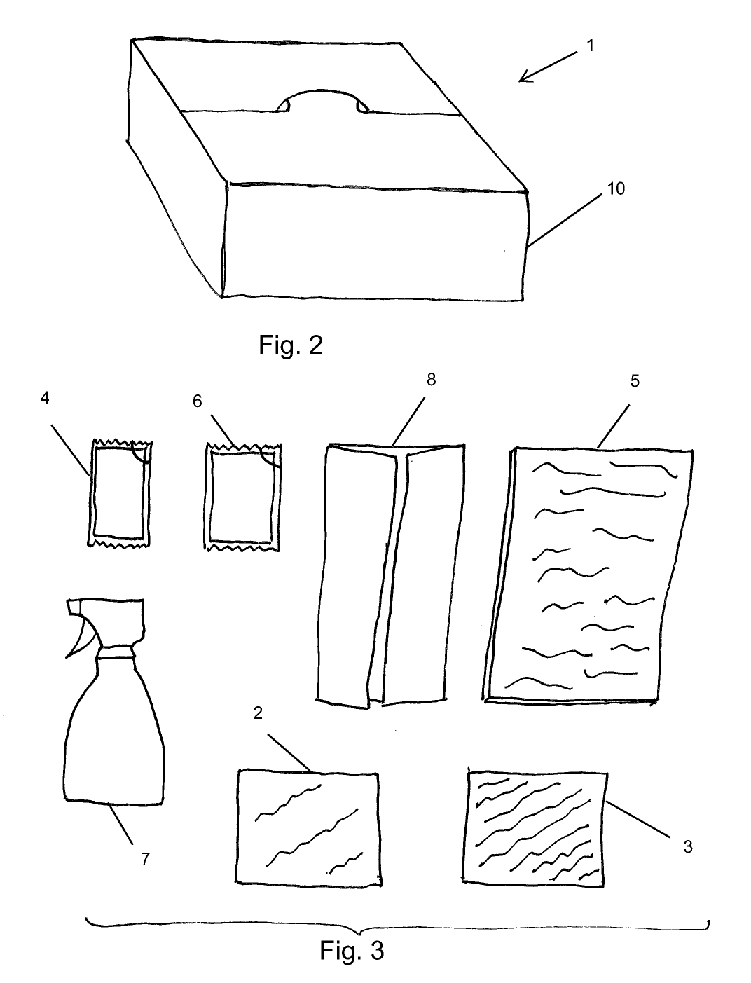

### DETAILED DESCRIPTION OF THE INVENTION

The following method is a preferred sequence of ordered steps for clarifying and sealing a headlight lens 102 of an automobile 100.

A kit 1 for headlight restoration can be sold to consumers seeking to restore the headlights of their personally-owned cars. The kit 1 has a box 10 in which the contents of the kit are held together so that they can be sold as a unit.

The box 10 of the kit 1 holds a coarse sandpaper sheet 2, a fine sandpaper sheet 3, a polishing-cream packet 4, a lint-free cloth 5, and a sealant packet 6. Because most households have paper towels 8 and a squirt bottles (which is preferably a trigger spayer) 7, and because these items are bulky, they can be omitted from embodiments of the kit. Alternatively, embodiments of the kit include the squirt bottle 7 and paper towels 8.

The first steps involve abrading the surface 103 of the lens 102 of the headlight 101. The abrading step removes oxidation from the surface 103 of the lens 102. Organic solvents are not necessary in the abrading steps.

In the first abrasion step, coarse sandpaper 2 is used. Coarse sandpaper 2 is defined as sandpaper with grit reaching one thousand 1000). The preferred grit for the first abrasion step is one thousand (1000) grit. The sandpaper is the type compatible with wet sanding. The surface 103 of the lens 102 is wetted with water, preferably, a squirt bottle 7 is used to wet the surface 103 of the lens 102. Sanding is continued in either a circular motion or side-to-side motion until the oxidation is removed from the surface 103 of the lens 102. A typical sanding time is three minutes to four minutes (3-4 min.) depending on the amount of oxidation and the size of the headlight 101.

After the first abrading step, the lens 102 is preferably wiped clean with a paper towel 8 and then rewetted with the squirt bottle 7. If necessary, the lens 102 may be rinsed with water to remove the “dust” from the sanding process.

Next, a second abrading step is performed using fine sandpaper 3. Fine sandpaper 3 is defined as paper with grit greater than one thousand (>1000). A preferred grit for the second abrading step is two thousand five hundred (2500). The fine sandpaper 3 is preferably the type compatible with wet sanding. The surface 103 of the lens 102 is sanded in a circular motion or a side-to-side motion. A typical sanding time is one minute to two minutes (1-2 min.) depending on the amount of oxidation and the size of the headlight.

After the fine sanding step, the surface 103 of the lens 102 is wiped and dried with a paper towel 8. If necessary, the lens may be rinsed with water from the squirt bottle 7 to remove the “dust” from the sanding process.

Next, the surface 103 of the lens 102 is polished. A polishing cream packet 4 is torn open and polishing cream is applied to the lens 102 with a lint-free airlay wiper 5. The lint-free wiper 5 preferably has dimensions of 6.4 cm by 21.6 cm. For storage before use, the lint-free wiper is folded into a square comprised of four layers approximately 6.4 cm by 6.4 cm. Polishing is accomplished by rubbing vigorously in small circles with firm pressure. The surface 103 of the lens 102 is polished for one to two minutes (1-2 min.) depending on the size of the lens 102.

After the abrading steps, the surface 103 of the lens 102 is thoroughly rinsed with water from the squirt bottle 7 to remove all residue from the abrading steps. Preferably, a paper towel 8 or equivalent absorptive towel is used. The lens 102 is completely dried with a paper towel 8.

The next step involves the clarification and sealing of the surface of the lens. A sealer packet 6 is torn open. A first coat of an aqueous urethane-modified acrylic sealer (i.e. “the sealer”) is applied with an airlay lint-free cloth 5. A cloth 5 having a size of 6.4 cm by 21.6 cm has been found to be useful for both application and for efficient storage before use. Before use, the cloth 5 is folded in a 6.4 cm by 6.4 cm square having four layers. The sealer is wiped across the surface 103 of the lens 102 in one direction from top to bottom with very light pressure until coverage is achieved. The first coat is allowed to dry, about two minutes (˜2 min.).

A second coat of the sealer is applied after the first coat has cured. The sealant for the second coat is preferably within the same sealant packet 6 as the first coat. The second coat is wiped across the lens 102 in the same direction as the first coating was applied: i.e. from top to bottom.

The first and second coat are held in the packet 6. The packet 6 is torn open and poured onto a lint-free cloth 5 for application. Preferably, the sealant packet 6 contains only enough for two coats to a pair of the largest headlight lenses (i.e. pickup-up truck headlights).

A preferred embodiment of the sealant has the following formulation. Quantities are given as percentages of the total weight of the sealant. When available, the CAS number of an ingredient is listed. If not available, the ingredient's CAS Number is merely listed as “proprietary”.

| INGREDIENT | % TW | C.A.S. # |
|---|---|---|
| Polydimethylsiloxane | 0.15-0.30% | proprietary |
| Flourosurfactant | 0.12-0.28% | 65545-80-4 |
| Preservative | 0.01-0.05% | proprietary |
| Styrenic acrylic emulsion | 8-13% | proprietary |
| Styrenic acrylic emulsion | 4.12-6.25% | proprietary |
| Polyetylene emulsion | 0.25-1.1% | proprietary |
| Polyurethane dispersion | 28-64.64% | proprietary |
| N-methyl-2-pyrolidone | 0.1-2.35% | 872-50-4 |

In one preferred embodiment, the invention encompasses a kit 1. The kit 1 is a disposable, single use kit that includes all of the materials that are not available in any household (i.e. paper towels and a squirt bottle) and with enough supplies to clarify and seal both headlights of only one automobile. The kit includes a piece of coarse sandpaper 2, a piece of fine sandpaper 3, a lint-free cloth 5, a packet of polish 4 with enough polish to polish up to two headlights of a large vehicle, a packet 6 of the sealant with enough sealant to provide two coats of sealant to both headlights of a car, and a lint-free cloth 5 for applying the sealant.

I claim:

1. A method of sealing a surface of a lens to prevent oxidation of the lens, which comprises:
applying a coating of an aqueous urethane-modified acrylic sealer to the surface, said aqueous urethane-modified acrylic sealer including an aqueous styrenic-acrylic emulsion.

2. The method according to claim 1, wherein said aqueous urethane-modified acrylic sealer further includes an aqueous polyethylene emulsion.

3. The method according to claim 1, which further comprises abrading the surface of the lens before applying said aqueous urethane-modified acrylic sealer.

4. The method according to claim 1, which further comprises applying a further coating of an aqueous urethane-modified acrylic sealer to the surface.

5. A method of sealing a surface of a lens to prevent oxidation of the lens, which comprises:
applying an aqueous urethane-modified acrylic sealer to the surface, said aqueous urethane-modified acrylic sealer including an aqueous polyethylene emulsion.

6. The method according to claim 5, which further comprises abrading the surface of the lens before applying said aqueous urethane-modified acrylic sealer.

7. The method according to claim 5, which further comprises applying a further coating of an aqueous urethane-modified acrylic sealer to the surface.

8. A method of clarifying and sealing a headlight lens, which comprises a sequence of steps:
wet abrading the surface of the headlight lens with water and sandpaper having a grit not exceeding 1000;
wet abrading the surface of the headlight lens with water and sandpaper having a grit from 1000 to 3000;
polishing the surface with a polishing cream;
rinsing the lens;
applying a first coat of aqueous urethane modified acrylic sealer to the surface by wiping said aqueous urethane modified acrylic sealer across the surface of the headlight lines in a top-to-bottom direction; and
applying a second coat of aqueous urethane modified acrylic sealer to the surface by wiping in said top-to-bottom direction;
said urethane modified acrylic sealer including a styrene acrylic emulsion, a polyethylene emulsion, a polyurethane dispersion, and no more than three percent by weight n-methyl-2-pyrolidone.

9. A composition for sealing a surface of a lens, comprising an aqueous urethane-modified acrylic sealer including an aqueous styrenic-acrylic emulsion.

10. The composition according to claim 9, wherein said aqueous urethane-modified acrylic sealer further includes an aqueous polyethylene emulsion.

11. The composition according to claim 9, wherein said composition includes an aqueous polyurethane emulsion.

12. The composition according to claim 9, wherein said composition includes no more than three percent by weight n-methly-2-pyrolidone.

13. A composition for sealing a surface of a lens, comprising an aqueous urethane-modified acrylic sealer including an aqueous polyethylene emulsion.

14. The composition according to claim 13, wherein said composition includes a polyurethane dispersion.

15. The composition according to claim 13, wherein said composition includes no more than three percent by weight n-methly-2-pyrolidone.

16. A kit for clarifying and sealing a surface of a pair of automobile headlights, comprising:
sandpaper having a grit no greater than 1000 for coarse abrading the surface of the automobile headlights;
sandpaper having a grit from 1000 to 3000 for fine abrading the surface of the automobile headlights;
a polishing cream for polishing the surface of the automobile headlight after abrading;
a lint-free cloth for applying said polishing cream; and
a volume of an aqueous urethane modified acrylic sealer including a styrene acrylic emulsion, a polyethylene emulsion, a polyurethane dispersion, and less than three percent by weight n-methyl-2-pyrolidone, said volume being sufficient to coat the surface of the headlights twice.
